(19) United States
(12) Patent Application Publication
(10) Pub. No.: US 2013/0024266 A1
(43) Pub. Date: Jan. 24, 2013

(54) METHOD FOR ENCOURAGING AND TRACKING VOLUNTEER PARTICIPATION AT AN ORGANIZED EVENT

(71) Applicant: Ryan SCOTT, Los Angeles, CA (US)

(72) Inventor: Ryan SCOTT, Los Angeles, CA (US)

(21) Appl. No.: 13/185,110

(22) Filed: Jul. 18, 2011

(51) Int. Cl. G06Q 30/00

(52) U.S. Cl. 705/14.36

(57) ABSTRACT

A non-profit agency may be provided with support from volunteers who may participate in a system that includes a web site reporting dates and places of volunteering events sponsored by the non-profit agency. Prospective volunteers may register to provide work-effort at a selected one of the events. Determination may be made as to whether or not the prospective volunteer actually provided work effort at the selected event. A reward may be provided to the volunteer if the volunteer actually provided work effort at the selected event.

### BACKGROUND OF THE INVENTION

The present invention generally relates to managing activities of groups of volunteer workers at charity-based events and more particularly to providing incentives to encourage participation of such volunteers.

Some organizations may elect to lend support to certain non-profit agencies by providing funds that may be used to procure incentives that may reward volunteer workers for their efforts at some volunteering events that may be sponsored by the non-profit agencies. For example, the organization may elect to provide funds for purchase and distribution of concert tickets or other tangible or intangible goods as rewards to volunteers who may chose to perform work at an activity such as a volunteering barbeque conducted by a non-profit agency.

An organization may choose to provide this reward-to-volunteer type of support to many different non-profit agencies. In this context, the organization may be faced with the task of determining when each of its supportees is conducting a volunteering event and also determining the identity of each volunteer who may have elected to provide work effort at the event.

As can be seen, there is a need for a system of tracking participation of volunteers at volunteering events and controlling distribution of rewards to such volunteers.

### SUMMARY OF THE INVENTION

In one aspect of the present invention, a method for providing support to a non-profit agency may comprise the steps of: reporting dates and places of volunteering events sponsored by the non-profit agency; allowing prospective volunteers to register to provide work-effort at a selected one of the events; determining whether or not the prospective volunteer actually provided work effort at the selected event; and providing a reward to the volunteer if the volunteer actually provided work effort at the selected event.

In another aspect of the present invention, a method for encouraging volunteer participation at a volunteering event may comprise the steps of: operating a website to allow prospective volunteers to register to provide work-effort at a particular one of the events; and issuing a reward to the registered volunteer after determining that the volunteer provided work effort.

In still another aspect of the invention, a computer program stored in a computer-recordable medium of a computer system may comprise: computer usable program code setting up a website; computer usable program code issuing a code unique to a prospective volunteer and to a particular event; computer usable program code accessing the website by the volunteer with the issued code; and computer usable program code generating a report of participation by the volunteer in the event responsively to the volunteer accessing the website with the issued code.

These and other features, aspects and advantages of the present invention will become better understood with reference to the following drawings, description and claims.

### BRIEF DESCRIPTION OF THE DRAWINGS

FIG. 1 is a flow chart of a method for providing support for a non-profit agency in accordance with an embodiment of the invention;

FIG. 2 is a flow chart of a method for tracking volunteer participation in accordance with an embodiment of the invention; and

FIG. 3 is an illustration of an exemplary web page constructed in accordance with an embodiment of the invention.

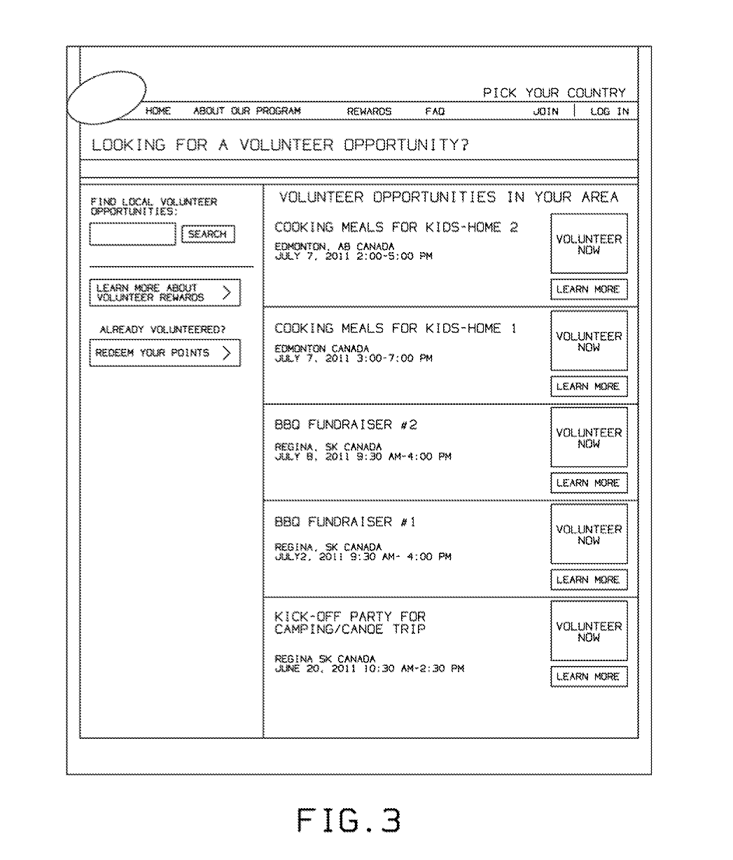

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a centralized volunteer tracking system through which a volunteer may receive an acknowledgment of his or her participation in volunteer work effort and then collect a reward for such participation.

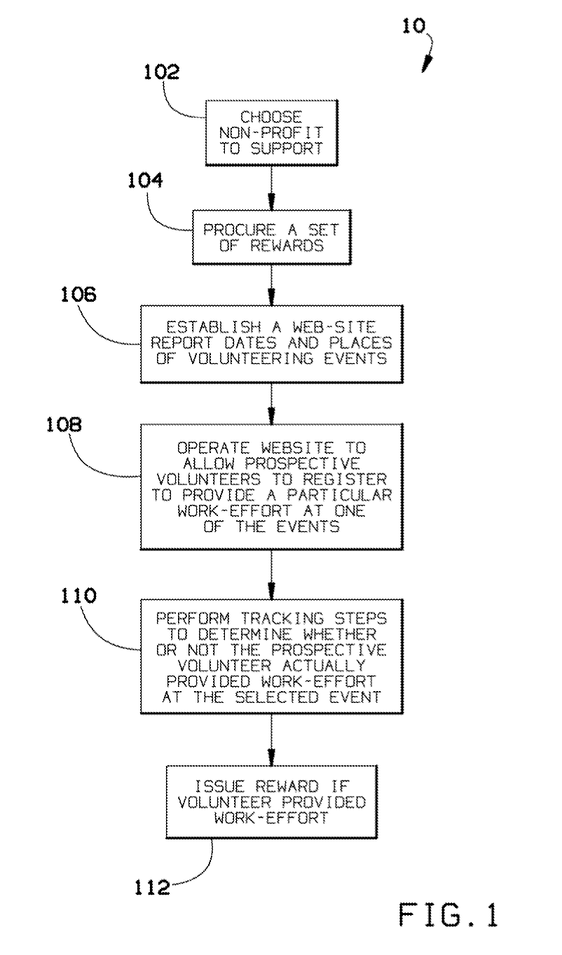

Referring now to FIG. 1, it may be seen that an exemplary embodiment of a method or system 10 for providing support to a non-profit agency may comprise the following steps. In a step 102, an organization, or its designee, may choose a non-profit agency or a group of non-profit agencies to support. In a step 104, the designee may procure a set of rewards. In a step 106, the designee may establish a web-site that may continuously report dates and places of volunteering events sponsored by the chosen non-profit agencies. In a step 108, the web-site may be operated to allow prospective volunteers to register to provide work-effort at a particular one of the events. In a step 110, the designee may perform tracking steps to determine whether or not the prospective volunteer actually provided work effort at the selected event. In a step 112, the volunteer may be provided with a reward based on the determination made in step 110.

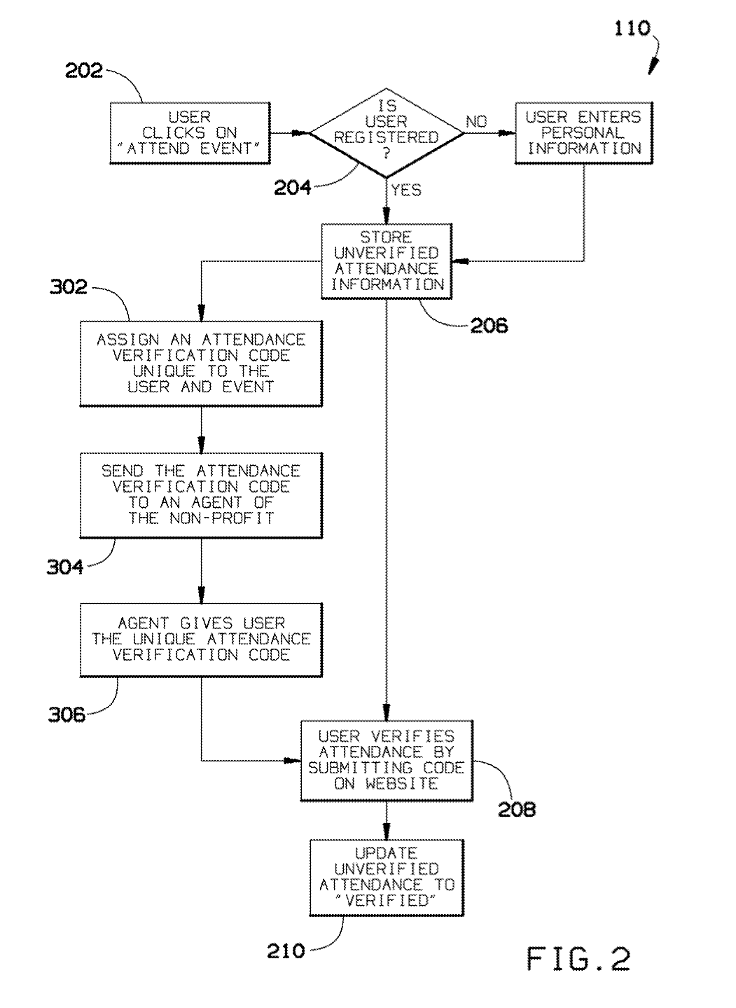

Referring now to FIG. 2, it may be seen that an exemplary embodiment of the tracking method 110 may comprise the steps shown in the flow chart. The tracking method 110 may comprise a series of initial steps performed by a prospective volunteer or user which may include step 202, in which user accesses website and elects to attend event, and step 206, in which unverified prospective attendance information may be stored. In a step 302, an attendance verification code, unique to the user and the event, may be assigned. Additionally, the method 110 may comprise a series of steps which may involve an agent of a non-profit that may be conducting a particular volunteering event. These agent-related steps may comprise steps 304, in which the attendance verification code may be sent to the agent, and step 306 in which the agent may give the verification code to the user upon determination that the user has performed work effort at the event.

In a step 208, the user may enter the verification code by accessing the website or by sending a message using SMS texting, thus verifying his or her attendance. In a step 210 the attendance of the user may be verified.

The method 110 may be implemented in a computing environment. A computer program may be stored in a computer-recordable medium of a computer system The program may comprise computer usable program code setting up a website, computer usable program code issuing a code unique to prospective volunteer and a particular event, computer usable program code allowing the volunteer to present the issued code by accessing the website or by sending a message using SMS texting, and computer usable program code generating a report of participation by the volunteer in the event.

It should be understood, of course, that the foregoing relates to exemplary embodiments of the invention and that modifications may be made without departing from the spirit and scope of the invention as set forth in the following claims.

What is claimed is:

1. A method for providing support to a non-profit agency comprising the steps of:
reporting dates and places of volunteering events sponsored by the non-profit agency.
allowing prospective volunteers to register to provide work-effort at a selected one of the events;
determining whether or not the prospective volunteer actually provided work effort at the selected event; and
providing a reward to the volunteer if the volunteer actually provided work effort at the selected event.

2. The method of claim 1 wherein the step of reporting dates and places and the step of allowing prospective volunteers to register is performed by operating a website.

3. The method of claim 1 wherein the step of determining whether or not the prospective volunteer actually provided work effort at the ,selected event comprises assigning an attendance verification code unique to the user and the event.

4. The method of claim 3 wherein the attendance verification code to an agent of the non-profit so that the code can be given to the registered volunteer by the agent after the volunteer provides the work effort.

5. The method of claim 1:
wherein all of the steps are performed by a designee of a organization and
wherein payment for the rewards is provided by the organization.

6. A method for encouraging volunteer participation at a volunteering event comprising the steps of:
operating a website to allow prospective volunteers to register to provide work-effort at a particular one of the events; and
issuing a reward to the a registered volunteer after determining that the volunteer provided work effort.

7. The method of claim 6 further comprising the steps of:
assigning an attendance verification code unique to the user and the event after the prospective volunteer registers; and
sending the attendance verification code to an agent of the non-profit so that the code can be given to the registered volunteer by the agent after the volunteer provides the work effort.

8. The method of claim 7 further comprising the step of accepting submission to the website of the code by the volunteer.

9. A computer program stored in a computer-recordable medium of a computer system comprising:
computer usable program code setting up a website;
computer usable program code issuing a code unique to a prospective volunteer and to a particular event;
computer usable program code accessing the website by the volunteer with the issued code; and
computer usable program code generating a report of participation by the volunteer in the event responsively to the volunteer accessing the website with the issued code.

10. The computer program of claim 9 further comprising computer usable program code issuing the code unique to a prospective volunteer and to a particular event to an agent of a non-profit agency sponsoring the event for subsequent delivery to the volunteer upon completion of the volunteer's work effort at the event.
